(19) United States
(12) Patent Application Publication
(10) Pub. No.: US 2005/0258756 A1
(43) Pub. Date: Nov. 24, 2005

(54) Low-pressure gas-discharge lamp having an electrode

(75) Inventors: Cornelis Johannes Denissen, Nuth (NL); Cornelis Ronda, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,133

(22) PCT Filed: Jul. 2, 2003
(86) PCT No.: PCT/IB03/03106

§ 371 Date: Jan. 12, 2005

(30) Foreign Application Priority Data
Jul. 17, 2002 (DE) 102 32 239.2

(51) Int. Cl. H01J 17/04; H01J 61/04

(52) U.S. Cl. 313/631

(57) ABSTRACT

A low-pressure gas-discharge lamp provided with a gas-tight discharge vessel that contains a gas filling, with electrodes for maintaining a gas discharge in the discharge vessel, at least one of which electrodes is arranged inside the discharge vessel and comprises a coil having a core made from a first metallic refractory material that has a first electronegativity, having a surrounding winding made from a second metallic refractory material that has a second electronegativity, having a coating of an electron-emitting material arranged between the core and the winding and having current feeds, and with means for starting and maintaining a gas discharge. The invention also relates to an electrode.

The invention relates to a low-pressure gas-discharge lamp that is equipped with a gas-tight discharge vessel that contains a gas filling, with electrodes for maintaining a gas discharge in the discharge vessel, at least one of which electrodes is arranged inside the discharge vessel and comprises a coil made from a refractory metal, which coil is electrically connected to current feeds and is coated with an electron-emitting material, and with means for starting and maintaining a gas discharge.

The generation of light in a low-pressure gas-discharge lamp is based on the ionization of the atoms of the filling gas in the lamp, and their resulting electrical discharge, when an electric current flows through the lamp. Electrons are emitted by the electrodes of the lamp and are so highly accelerated by the electrical field between the electrodes that they are able to excite and ionize the atoms of the gas when they collide with them. When the gas atoms return to their ground state and the electrons and ions recombine, a proportion of the potential energy of greater or lesser size is converted into radiation.

The quantity of electrons that can be emitted by the electrodes depends on the work function of the electrodes for electrons. Tungsten, the metal that is generally used as an electrode metal, has a relatively high work function. The electrode metal is therefore usually also coated with a material whose job it is to improve the electron-emitting properties of the electrode metal. It is characteristic of electron-emitting coating materials for electrodes in gas-discharge lamps that they contain an alkaline-earth metal either in the form of the oxide of the alkaline-earth metal or in the form of a precursor of the oxide of the alkaline-earth metal, which precursor contains the alkaline-earth metal. As a rule, low-pressure gas-discharge lamps of the conventional kind are thus fitted with electrodes that comprise tungsten wires having an electron-emitting coating that contains oxides of the alkaline-earth metals calcium, strontium and barium.

To manufacture an electrode of this kind, the tungsten wire is usually coated with the carbonates of the alkaline-earth metals in a binder preparation. During the process of evacuating and baking the lamp, the carbonates are converted into the oxides at temperatures of approximately 1000° C. After it has been “burnt off” in this way, the electrode already provides an appreciable emission current but this is still unstable. There generally follows an activation process as well. The activation process converts the originally non-conductive ion lattice of the alkaline-earth oxides into an electronic semiconductor. In the course of this, impurities of the donor type are incorporated into the crystal lattice of the oxides. These impurities comprise essentially elemental alkaline-earth metal, e.g. calcium, strontium or barium. The electron emission of electrodes of this kind is based on this impurity mechanism. The purpose of the activation process is to create an adequate amount of excess elemental alkaline-earth metal that will enable the oxides in the electron-emitting coating to produce a maximum emission current at a prescribed heating power.

It is important to the operation of such electrodes and to the life of the lamp, that there should be a constantly renewed supply of fresh elemental alkaline-earth metal. The electrode coating does in fact constantly lose alkaline-earth metal during the life of the lamp because some of the coating as a whole slowly vaporizes and some of it is sputtered off by the ion current in the lamp.

While the lamp is operating, there is, initially, a constant re-supply of the elemental alkaline-earth metal as a result of the reduction of the alkaline-earth oxide on the tungsten wire. This re-supply comes to a halt however when, in the course of time, the tungsten wire becomes passivated by a high-resistance interface of tungsten oxide, alkaline-earth silicate or alkaline-earth tungstate.

EP 1104933 attempts to overcome this fact. EP 1104933 describes a gas-discharge lamp fitted with an electrode that comprises a carrier made from an electrode metal selected from the group comprising tungsten and the tungsten-containing allows, and a first coating of a first electron-emitting material that contains an alkaline-earth metal oxide selected from the group comprising calcium oxide, strontium oxide and barium oxide and a rare-earth metal oxide selected from the group comprising scandium oxide, yttrium oxide and europium oxide in an amount a of from 0.1 to 10% by weight.

What is disadvantageous, however, is that if the electrode metal overheats, the barium vaporizes slightly and the electrode thus loses its ability to emit.

It is, therefore, an object of the present invention to provide a low-pressure gas-discharge lamp having an extended life and improved emission current.

In accordance with the invention, this object is achieved by a low-pressure gas-discharge lamp that is equipped with a gas-tight discharge vessel that contains a gas filling, with electrodes for maintaining a gas discharge in the discharge vessel, at least one of which electrodes is arranged inside the discharge vessel and comprises a coil having a core made from a first refractory metallic material that has a first electronegativity, having a surrounding winding made from a second refractory metallic material that has a second electronegativity, having a coating of an electron-emitting material arranged between the core and the winding, and having current feeds, and with means for igniting and maintaining a gas discharge.

Because the core of the coil and the winding surrounding it are made from refractory metallic materials that are of different electronegativities, the two functions of the coil, namely to conduct current and to continuously reduce the electron-emitting coating, are separated from one another. The reduction takes place preferably in the less electronegative material. As a result of the separation of the two processes, the emission mechanism is better able to be optimized and effective use is made of the electron-emitting substance as a whole.

In one embodiment of the invention, the core is composed of a first refractory material having a higher electronegativity and the surrounding winding of a second refractory material having a lower electronegativity.

It is particularly preferable for the core to be composed of a first refractory material having a higher electronegativity that is selected from the group comprising tungsten and the alloys of tungsten alloyed with zirconium, hafnium, titanium, yttrium, scandium, lanthanum or the lanthanides, and the surrounding winding of a second refractory material having a lower electronegativity that is selected from the group comprising zirconium, hafnium, titanium, yttrium, scandium, lanthanum or the lanthanides.

This embodiment is particularly suitable for low-pressure gas-discharge lamps having a low lamp current (gas-discharge current). The electrode temperature too is low in such lamps. The use of materials having a lower electronegativity promotes the reducing reaction even at low temperature and prevents any unnecessary vaporization of constituents from the electron-emitting coating.

In an especially preferred embodiment of the invention for low-pressure gas-discharge lamps having a low gas-discharge current, the surrounding winding contains zirconium and the electron-emitting material contains barium and strontium. In this embodiment, it is preferable for the electron-emitting coating to be free of a calcium-containing emitter.

In another embodiment of the invention, the core is composed of a first refractory material having a lower electronegativity and the surrounding winding of a second refractory material having a higher electronegativity.

It is particularly preferable for the core to be composed of a first refractory material having a lower electronegativity that is selected from the group comprising tungsten and the alloys of tungsten alloyed with zirconium, hafnium, titanium, yttrium, scandium, lanthanum or the lanthanides, and the surrounding winding of a second refractory material having a higher electronegativity that is selected from the group comprising rhenium, cobalt, nickel, ruthenium, palladium, rhodium, iridium, osmium and platinum.

This embodiment is particularly suitable for low-pressure gas-discharge lamps having a high lamp current (gas-discharge current). The electrode temperature too is relatively high in such lamps. The use of materials having a high electronegativity prevents an excessive reducing reaction.

In a further embodiment of the invention, the coating of an electron-emitting material contains a polymeric multiple barium tungstate. This embodiment is notable for the simplified activation of the low-pressure gas-discharge lamp and for improved electron emission.

The invention also relates to an electrode, comprising a coil having a core made from a first refractory metallic material that has a first electronegativity, having a surrounding winding made from a second refractory metallic material that has a second electronegativity, having a coating of an electron-emitting material arranged between the core and the winding, and having current feeds.

These and other aspects of the invention are apparent from and will be elucidated with reference to the embodiments described hereinafter.

In the drawings:

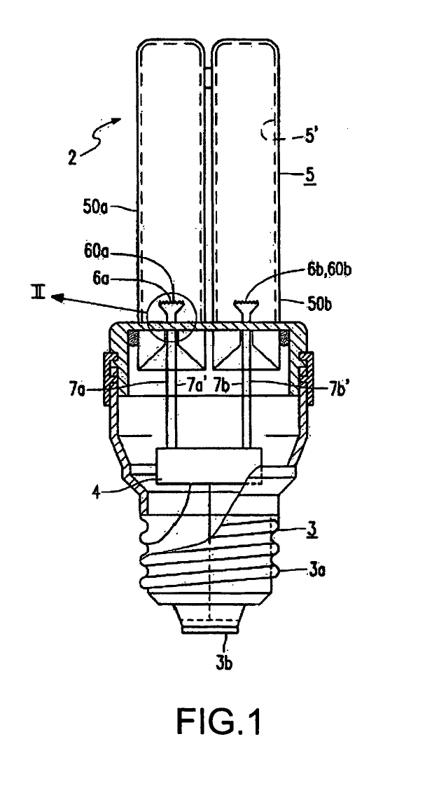

FIG. 1 shows by way of example a compact low-pressure gas-discharge lamp.

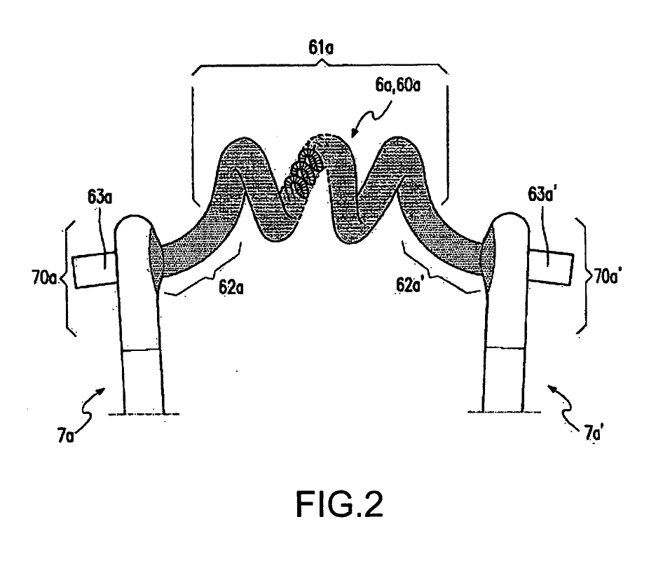

FIG. 2 shows an electrode in detail.

FIG. 1 shows by way of example a compact low-pressure gas-discharge lamp having a housing 1 that carries the low-pressure gas-discharge lamp 2. The housing also carries a lamp-cap 3 having contacts 3a, 3b. Also accommodated in the housing is an ignition device 4. The ignition device 4 is connected to the contacts 3a, 3b. The lamp further comprises means for starting and operation, e.g. a choke and a starter.

The low-pressure gas-discharge lamp is fitted with a gas-discharge vessel 5 that is sealed with a gas-tight seal.

The interior of the gas-discharge vessel is provided with a layer 5′ of phosphor whose chemical composition determines the spectrum of the light or its color. The gas-discharge vessel contains an ionizable filling of gas, usually an inert-gas filling of argon together with a small quantity of mercury or mercury vapor that is excited to luminesce under operating conditions and that emits the Hg resonance line at a wavelength of 253.7 nm in the ultraviolet range. The UV radiation that is emitted excites the phosphors in the phosphor layer to emit light in the visible range.

A gas-discharge lamp according to the invention further comprises electron-emitting electrodes 6a, 6b for maintaining an electric discharge in the gas-discharge vessel.

At least one of the electrodes 6a, 6b is arranged inside the gas-discharge vessel 5. In the embodiment shown in FIG. 1 both the electrodes are arranged inside the gas-discharge vessel, at respective ones of the two ends 50a, 50b of the U-shaped gas-discharge vessel.

The electrodes 6a, 6b comprise respective coils 60a, 60b that are electrically connected to the current feeds 7a, 7a′, 7b, 7b′.

FIG. 2 shows one 6a of the electrodes in detail. The other electrode 6b is identical in construction. The coil 60a of the electrode 6a has as a surrounding winding three turns of a tertiary helix that are formed by 57 turns of a secondary helix that in turn are formed from wire coiled in a primary helix. The space at the center of the surrounding winding is filled by a thick core wire (not shown). Between the end regions 62a, 63a and 62a′, 63a′, the coil 60a has a central region 61a occupied by 45 turns of the secondary helix. The central region is coated with electron-emitting material. The coil 6a is fastened to the loops 70a, 70a′ at the ends of the current feeds 7a, 7a′.

The electrodes according to the invention generally comprise a core and a surrounding winding.

The core may take the form of a wire, coil, helix, corrugated wire, tube, ring, plate or strip. It is generally heated directly by the flow of current.

The winding surrounding the coil may comprise one or more wires (basket wires). A plurality of wires may also be twisted into a stranded conductor for the surrounding winding. Also known are electrodes in which a core wire first has wires wound round it at a high pitch and a further surrounding winding is then placed round this whole at a short pitch.

Electrodes that have twisted wires as a core and are provided on the outside with an additional winding have also already been produced.

What have also become known are forms of electrode in which the individual wires of the surrounding winding are not connected into a stranded conductor simply by being looped around one another but are actually braided together. In braiding, the individual wires in the outer layer do not run round the core in one direction only but are either passed round the core alternately in one direction or the other or else a plurality of individual wires are first braided together to form a stranded wire and the stranded wires are then wound around the core in turn by braiding, i.e. alternately clockwise and counterclockwise.

Also known are electrodes formed from wires twisted into stranded conductors that are first produced in the form of a closed stranded conductor that comprises a core wire and a first lay of six separate wires of the same diameter, of which certain ones are then dissolved chemically. These latter wires are therefore made from a different material than the others.

It is not necessary for the core wire always to remain in the interior and it can in fact take part in the mutual change in position between the wires.

The refractory metallic materials that can be used for the electrodes are determined not only by good conductivity and a good work function by also by their electronegativity.

The core of the coil of a metallic refractory material is usually composed of tungsten or a tungsten alloy with, if required, a center of molybdenum. What are preferred are alloys obtained by adding 0.0 1 to 1% by weight of hafnium, zirconium or titanium to tungsten. These added elements act as reducing agents that further increase the reducing action of the high-melting-point metallic material. It is especially preferable for the core composed of a first refractory material having a higher electronegativity to be selected from the group comprising tungsten and the alloys of tungsten alloyed with zirconium, hafnium, titanium, yttrium, scandium, lanthanum and the lanthanides.

In one embodiment of the invention, the winding surrounding the coil of a refractory metallic material is composed of a second refractory material of lower electronegativity selected from the group comprising zirconium, hafnium, titanium, yttrium, scandium, lanthanum and the lanthanides. This embodiment is particularly suitable for lamps having a low lamp current.

In another embodiment of the invention, the winding surrounding the coil of a refractory metallic material is composed of a second refractory material of higher electronegativity selected from the group comprising rhenium, cobalt, nickel, ruthenium, palladium, rhodium, iridium, osmium and platinum.

In one embodiment of the invention, the refractory metallic material may be composed of a substrate on which is arranged a coating of a noble metal selected from the group comprising rhenium, cobalt, nickel, ruthenium, palladium, rhodium, iridium, osmium and platinum. The coating is preferably composed of a 0.1 to 2 μm thick layer of iridium or rhenium.

The individual wires of the surrounding winding according to the invention may all be composed of the same material, such as tungsten, for example. However, it is also possible for individual wires of other materials to be incorporated for particular purposes, wires of tantalum, zirconium or another metal for example thus being incorporated in the winding as well as a certain number of tungsten wires.

Between the core and the surrounding winding, there are generally continuous gaps created that improve the adhesion of the coating of an electron-emitting material.

The raw material for the electron-emitting substance of a first coating is applied to the coil between the core and the surrounding winding. To produce the raw material for this coating, the carbonates of alkaline-earth metals selected from the group comprising calcium, strontium and barium, are mixed with an oxide of a rare-earth metal selected from the group comprising scandium oxide, yttrium oxide and europium oxide in a proportion a of from 0.1 to 10% by weight. The proportions by weight of calcium carbonate to strontium carbonate to barium carbonate are typically 1:1.25:6 or 1:12:22 or 1:1.5:2.5 or 1:4:6.

Alternatively, the mixture of alkaline-earth oxides and rare-earth-metal oxide may be produced by co-precipitation by adding to a solution of the alkaline-earth nitrates a waters-soluble compound of the rare-earth metals and then precipitating the alkaline-earth carbonates and the rare-earth-metal oxides by adding sodium carbonate.

The electron-emitting material may contain other constituents selected from the group of binary oxides comprising titanium oxide, zirconium oxide, hafnium oxide, cerium oxide and lanthanum oxide.

The electron-emitting material may contain other constituents selected from the group of ternary and quaternary oxides comprising Ba₃WO₆, Ba₂CaWO₆, BaY₂O₄, Ba₄Ta₂O₉, Ba₂TiO₄ and BaZrO₃.

The emitter material is more uniformly dispersed by these other constituents and it may be more uniformly reduced by them.

The electron-emitting material may also have added to it a powdered form of the metals from the group comprising aluminum, silicon, titanium, zirconium, hafnium, tantalum, molybdenum, tungsten and alloys thereof formed with a metal from the group comprising rhenium, rhodium, palladium, iridium and platinum, which powdered metal is provided with a powder coating composed of iridium, rhenium, rhodium, platinum, palladium, nickel or cobalt. A powdered metal having a mean grain size of 2-3 m and a 0.1 to 0.2 m thick powder coating is preferably used. CVD processes or fluid-bed CVD processes may be used as powder-coating processes. This coated powdered metal is added to the raw material.

The raw material may also be mixed with a binder. It may be applied to the substrate by brushing, dipping, cataphoretic deposition or spraying.

The prefabricated electrodes are fused into the ends of the lamp. The electrodes are seasoned during the evacuation and filling of the lamp. The electrode wire is heated to a temperature of from 1000° C. to 1200° C. by the direct passage of current. At this temperature, the alkaline-earth carbonates are converted into alkaline-earth oxides while releasing CO and CO₂ and then form a porous, sintered body. After this “burning off” of the electrodes, the activation takes place, the purpose of which is to produce excess elemental barium incorporated in the oxides. The excess barium is produced by the reduction of barium oxide. In the reducing activation proper, barium oxide is reduced by the CO that is released or by the substrate metal. Added to this there is a current activation that enables the required free barium to be created by electrolytic processes at high temperatures.

In another embodiment of the invention, the coating of an electron-emitting material contains as a supplier of free barium a ternary, quaternary, pentary or generally multiple salt of barium having a polymeric tungstate anion.

These polymeric tungstates are characterized by the fact that the anion is that of a mono-oxo, isopolyoxo or heteropolyoxo acid of tungsten and an element from the series comprising titanium, zirconium, hafnium, tantalum, yttrium and cerium acts as a heteroatom in the heteropolyoxo acids.

The anions of the salts according to the invention have different structures and valences. The structure that they have is very much dependent on pH. Whereas in alkaline solutions it is essentially the mono-oxo anions that are present, these condense into isopolyoxo anions as pH goes down. It is also possible for a plurality of anions of different structures to be present in the polymeric salts.

As well as barium the tungstate may also contain one or more other alkaline-earth metals selected from the group comprising cadmium and manganese as cations.

With this embodiment, the thermal breakdown of the alkaline-earth carbonates into binary alkaline-earth oxides is dispensed with during the activation of the lamp.

When the lamp is operating, the electron-emitting material then slowly vaporizes under the ion bombardment at the hot spot of the electrode.

1. A low-pressure gas-discharge lamp equipped with a gas-tight discharge vessel that contains a gas filling, with electrodes for maintaining a gas discharge in the discharge vessel, at least one of which electrodes is arranged inside the discharge vessel and comprises a coil having a core made from a first refractory metallic material that has a first electronegativity, having a surrounding winding made from a second refractory metallic material that has a second electronegativity, having a coating of an electron-emitting material arranged between the core and the winding, and having current feeds, and with means for igniting and maintaining a gas discharge.

2. A low-pressure gas-discharge lamp as claimed in claim 1, characterized in that the core is composed of a first refractory material having a higher electronegativity and the surrounding winding of a second refractory material having a lower electronegativity.

3. A low-pressure gas-discharge lamp as claimed in claim 1, characterized in that core is composed of a first refractory material having a higher electronegativity that is selected from the group comprising tungsten and the alloys of tungsten alloyed with zirconium, hafnium, titanium, yttrium, scandium, lanthanum or the lanthanides, and the surrounding winding is composed of a second refractory material having a lower electronegativity that is selected from the group comprising zirconium, hafnium, titanium, yttrium, scandium, lanthanum or the lanthanides.

4. A low-pressure gas-discharge lamp as claimed in claim 1, characterized in that the core is composed of a first refractory material having a lower electronegativity and the surrounding winding of a second refractory material having a higher electronegativity.

5. A low-pressure gas-discharge lamp as claimed in claim 1, characterized in that the core is composed of a first refractory material having a lower electronegativity that is selected from the group comprising tungsten and the alloys of tungsten alloyed with zirconium, hafnium, titanium, yttrium, scandium, lanthanum or the lanthanides, and the surrounding winding is composed of a second refractory material having a higher electronegativity that is selected from the group comprising rhenium, cobalt, nickel, ruthenium, palladium, rhodium, iridium, osmium and platinum.

6. A low-pressure gas-discharge lamp as claimed in claim 1, characterized in that the coating of an electron-emitting material contains a polymeric multiple barium tungstate.

7. An electrode, comprising a coil having a core made from a first refractory metallic material that has a first electronegativity, having a surrounding winding made from a second refractory metallic material that has a second electronegativity, having a coating of an electron-emitting material arranged between the core and the winding, and having current feeds.
